(19) United States
(12) Patent Application Publication
(10) Pub. No.: US 2024/0193267 A1
(43) Pub. Date: Jun. 13, 2024

(54) METHODS AND SYSTEMS FOR CYBER THREAT ANALYSIS

(71) Applicant: Renze JONGMAN, Abu Ddhabi (AE)

(72) Inventor: Renze JONGMAN, Abu Ddhabi (AE)

(21) Appl. No.: 18/063,925

(22) Filed: Dec. 9, 2022

(51) Int. Cl. G06F 21/55

(52) U.S. Cl. CPC G06F 21/554; G06F 2221/033

(57) ABSTRACT

Methods and systems for cyber threat analysis are disclosed. The method includes aggregating threat feeds corresponding to threat-related event(s) from cyber threat-related sources. The method includes accessing threat entities from a threat library. The method also includes identifying threat element(s) corresponding to at least one threat entity of the threat entities, in at least one threat feed. The method includes the at least one threat feed with the at least one threat entity, based at least on the identification of the threat element(s). The method includes generating threat-related insights on the threat-related events, based at least on the linking. The method also includes assigning a predefined rating to the at least one threat feed that is linked with the at least one threat entity, based at least on the threat-related insights and the threat severity rating associated with each of the threat entities.

### TECHNICAL FIELD

The present disclosure relates to the field of cyber security and, more particularly to methods and systems for cyber threat analysis.

### BACKGROUND

Over the past few decades, it has been observed that cybercrimes have increased in frequency and severity. Large retail outlets are hacked, credit cards are exposed, and millions of dollars in losses are sustained by affected institutions. A cyber threat or a cybersecurity threat is a malicious act that seeks to damage data, steal data, or disrupt digital life in general. Cyber threats include computer viruses, data breaches, malware, spyware, phishing attacks, and other attack vectors. Cyber threats also refer to the possibility of a successful cyber-attack that aims to gain unauthorized access, damage, disrupt, or steal an information technology asset, computer network, intellectual property, or any other form of sensitive data. Cyber threats can come from within an organization by trusted users or from remote locations by unknown parties.

Many organizations or resources act as central resources for gathering information on cyber threats as well as allow two-way sharing of information between the private and the public sector about root causes, incidents, and threats, as well as sharing experience, knowledge, and analysis. Threat information sharing provides access to the threat information that might otherwise be unavailable to an organization. Using shared resources, organizations can enhance their security posture by leveraging their knowledge, and experience in a proactive way.

However, it is very challenging for organizations and teams to keep themselves up to date with each and every threat and to be on top of all the cyber news published daily. Keeping track of all the published reports by vendors for which the organization has paid or subscribed to and keeping a trail of alerts for any “trip-wires” the organization may have set up when tracking criminal infrastructure or malware, is also difficult and time-consuming for the organizations.

Thus, there exists a technological need for a single platform where security teams can aggregate all their intelligence events and sources into one place.

### SUMMARY

Various embodiments of the present disclosure provide methods and systems for providing insights into cyber threats by analyzing threat feeds using a threat analysis platform.

In an embodiment, a computer-implemented method is disclosed. The computer-implemented method includes aggregating a plurality of threat feeds corresponding to one or more threat-related events, from a plurality of cyber threat-related sources. The computer-implemented method further includes accessing a plurality of threat entities from a threat library. The threat library includes a threat severity rating for each of the plurality of threat entities. The computer-implemented method includes identifying one or more threat elements corresponding to at least one threat entity of the plurality of threat entities, in at least one threat feed of the plurality of threat feeds. The computer-implemented method further includes linking the at least one threat feed with the at least one threat entity, based at least on the identification of the one or more threat elements in the at least one threat feed, for categorizing the one or more threat-related events under a predefined threat category. Furthermore, the computer-implemented method includes generating one or more threat-related insights on the one or more threat-related events, based at least on the linking. The computer-implemented method also includes assigning a predefined rating to the at least one threat feed that is linked with the at least one threat entity, based at least on the one or more threat-related insights and the threat severity rating associated with each of the plurality of threat entities in the threat library.

In another embodiment, a server system is disclosed. The server system includes a communication interface and a memory including executable instructions. The server system also includes a processor communicably coupled to the memory. The processor is configured to execute the instructions to cause the server system, at least in part, to aggregate a plurality of threat feeds corresponding to one or more threat-related events, from a plurality of cyber threat-related sources. The server system is further caused to access a plurality of threat entities from a threat library. The threat library includes a threat severity rating for each of the plurality of threat entities. The server system is further caused to identify one or more threat elements corresponding to at least one threat entity of the plurality of threat entities, in at least one threat feed of the plurality of threat feeds. The server system is further caused to link the at least one threat feed with the at least one threat entity, based at least on the identification of the one or more threat elements in the at least one threat feed, for categorizing the one or more threat-related events under a predefined threat category. The server system is further caused to generate one or more threat-related insights on the one or more threat-related events, based at least on the linking. The server system is further caused to assign a predefined rating to the at least one threat feed that is linked with the at least one threat entity, based at least on the one or more threat-related insights and the threat severity rating associated with each of the plurality of threat entities in the threat library.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment related to at least some example embodiments of the present disclosure;

FIG. 2A illustrates a simplified block diagram of a server system, in accordance with an embodiment of the present disclosure;

FIG. 2B illustrates a simplified block diagram representing examples for a plurality of threat-related sources and content of a threat library, in accordance with an embodiment of the present disclosure;

FIG. 3 is a flow diagram depicting a process flow of analyzing the plurality of threat feeds, in accordance with an embodiment of the present disclosure;

FIG. 4 is a flow diagram depicting a process flow of rating the plurality of threat feeds, in accordance with an embodiment of the present disclosure;

FIGS. 5A, 5B, 5C, and 5D, collectively, represent an example representation of User Interfaces (UIs) rendered in an application for cyber security analysis, in accordance with an example embodiment of the present disclosure;

FIG. 6 is a flowchart illustrating a computer-implemented method for cyber threat analysis, in accordance with an embodiment of the present disclosure; and

FIG. 7 is a simplified block diagram of an electronic device, in accordance with an embodiment of the present disclosure.

The drawings referred to in this description are not to be understood as being drawn to scale except if specifically noted, and such drawings are only of example in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The terms “threat-related data” and “threat-related information” may have been used interchangeably throughout the description, and unless the context suggests otherwise, these terms generally refer to any data or information related to a threat.

The term “threat event” may have been used throughout the description, this term generally refers to the occurrence of any threat-related incident that takes place anywhere in the world.

The term “threat feeds” may have been used throughout the description, this term generally refers to any informational article disclosing or uncovering the threat-related information and threat-related incidents for making the public aware of it.

The term “threat library” may have been used throughout the description, this term generally refers to a storage that not only includes threat-related information defined or stored by the user but also includes, the historic data related to previously observed cyber-attacks. The historic data may be extracted from different threat sources

The term “threat element” may have been used throughout the description, this term generally refers to elements or words corresponding to the threat entities in the threat library.

The term “threat entities” may have been used throughout the description, this term generally refers to pre-stored data analyzed by software developers and/or cyber threat analysts of previously observed cyber-attacks.

The term “cyber threat-related source” may have been used throughout the description, this term generally refers to any communication tools or channels used to present information such as articles, news, reports, and the like related to cyber threats.

### Overview

Various embodiments of the present disclosure provide methods and systems for aggregating and analyzing information related to cyber threats to provide insights about the latest cyber threats published in the market. In one embodiment, the disclosed system may be embodied as a platform or a mobile application such as, but not limited to, a threat analysis platform. The term “threat analysis platform” refers to a platform or an application that provides an alert in real-time to users of the application about any new cyber threat published on any threat-related sources. The system provides the insights about latest threats to the users by aggregating threat feeds (information related to cyber threats) related to threat events, from every single cyber threat-related source. The cyber threat-related sources may include an open source, a premium source, a software as a service (SaaS) tooling, and the like. The threat events may be an event of occurrence of a cyber threat such as publishing of threat news, tweets about new cyber threats, reports about new cyber threats from threat vendors and researchers, and the like. Further, the threat analysis platform aggregates and categorizes the threat events for providing insights about the latest threats to the users. The threat feeds may include articles, news, updates, and the like about the latest cyber threats in the market.

As it is known that a cyber threat is a malicious act that seeks to damage data, steal data, or disrupt digital life in general, security from such cyber threats may have to be established. Such a security may be a threat security. The term “threat security” may refer to the practice of defending computers, servers, mobile devices, electronic systems, networks, and data from malicious attacks. Securing an organization or entity from such threats can be done by actively hunting unknown or lurking threats that describe new and novel attack behaviors. Thus, the system provides a convenient way for organizations to immediately understand the current state of the cyber threats.

Furthermore, the system accesses a threat library for identifying different cyber threats in the aggregated threat feeds. The system searches for threat elements that are related to threat entities, in the threat feeds. The threat elements include words, synonyms, regexes, and the like that are related to the threat entities present in the threat library. The threat entities may be pre-stored in the threat library. The threat entities may be stored in the threat library by categorizing them under different threat categories such as, but not limited to, threat actors, malware families, vulnerabilities, keywords, threat clusters, and the like. At least one threat feed having the threat elements that are related to the threat entities from the threat library may then be linked with at least one threat entity. By linking, the threat events related to the corresponding at least one threat feed further get categorized under a predefined threat category. Further, the system generates the insights corresponding to the cyber threats, based at least on the linking.

Later, the system also provides a rating to the threat feeds, based on the insights and a severity level of the cyber threats predefined in the threat library. The severity level associated with the cyber threats may be baseline, low, medium, high, severe, and emergency, and information about the severity level is obtained from the threat library. Further, based on the rating assigned to the threat feeds, the cyber threats are prioritized in terms of which of the cyber threats to be addressed first. Furthermore, the system also generates alerts to the users about the cyber threats, based at least on the prioritization of the cyber threats. Later, the valuable insights are displayed on a user interface (UI) associated with the threat analysis platform.

Moreover, the system also generates a threat card for the at least one threat entity that is linked with the at least one threat feed. The threat card may include insights on the at least one threat entity, event details about the threat events related to the at least one threat feed, a list of threat sources from where the at least one threat feed is obtained, timestamp, and the like. Further, the valuable insights may be displayed to the users in the form of the threat card. Later, content of the threat library is updated based on identification of the new cyber threats, as the cyber threats evolve and understanding of the users about the cyber threats evolve.

The cyber threat-related sources from which the threat feeds are aggregated by the system, are also rated based on a ‘read reports’ percentage, wherein the ‘read reports’ percentage is greater than or equal to a predetermined threshold value. Further, a popularity of the cyber threat-related sources may be known based on the rating allocated to the cyber threat-related sources. Moreover, rating and categorizing save a lot of time when an analyst wants to dive deeper into a certain threat type because all the relevant reports and links would already be available on the platform. Further, the user also gets notified or receives alerts regarding the cyber threats that are top rated in real-time, as all the sources are continuously monitored automatically.

Further, various embodiments of the present disclosure offer multiple advantages and technical effects. For instance, the present disclosure facilitates the user with automatic continuous monitoring of all the cyber threat-related sources to check for occurrence of new cyber threat in the market. This reduces the burden of the user to actively think and go through all of the cyber threat-related sources regularly to see if there are new cyber threats to be added to the threat library. Further, the cyber threat-related sources, the cyber threats, and the alerts are automatically prioritized and categorized. This saves a lot of time when an analyst wants to dive deeper into a certain threat type because all the relevant reports and links will already be available on the platform.

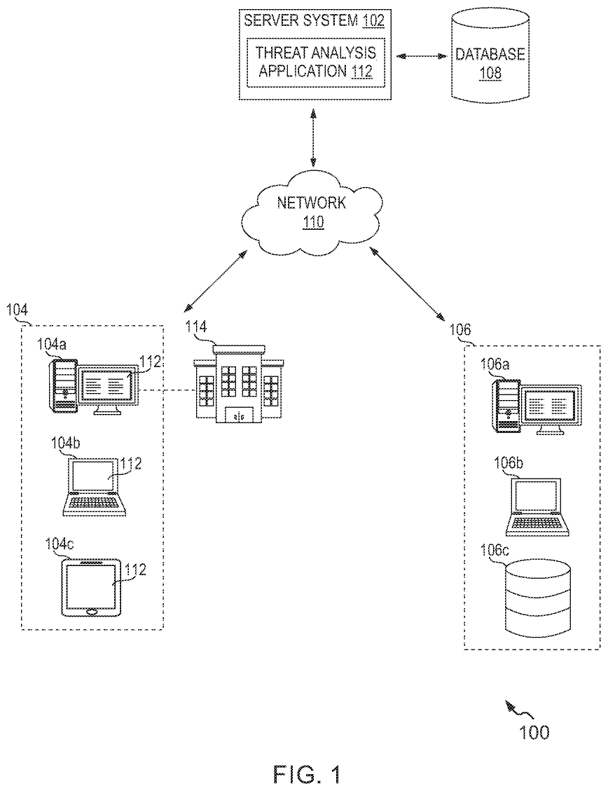

Various example embodiments of the present disclosure are described hereinafter with reference to FIGS. 1 to 7.

FIG. 1 illustrates an example representation of an environment 100 related to at least some example embodiments of the present disclosure. Although the environment 100 is presented in one arrangement, other embodiments may include the parts of the environment 100 (or other parts) arranged otherwise depending on, for example, aggregating and bringing all threat-related information together at one platform and presenting them to a user. The system may present the threat-related information to the user in a way that allows the user to view one overview of what the current prioritized threat landscape looks like. To bring the threat-related information from all the sources together in one platform requires building custom integrations per source and per tool, which is explained in detail in the present disclosure.

The example representation of the environment 100 as depicted in FIG. 1 includes a server system 102, a plurality of user devices 104a, 104b, and 104c (also referred to as user devices 104) associated with a plurality of users (also referred to as users), a plurality of cyber threat-related sources 106a, 106b, and 106c (also referred to as threat sources 106), and a database 108 connected to, and in communication with (and/or with access to) a wireless communication network (e.g., a network 110).

In an embodiment, the server system 102 is deployed as a standalone server or can be implemented in cloud as software as a service (Saas). The server system 102 provides or hosts a threat analysis application 112 for performing cyber threat analysis by aggregating a plurality of threat feeds from the threat sources 106. An instance of the threat analysis application 112 is also accessible to the user devices 104 as shown in the environment 100 in FIG. 1. This is enabled by installing the threat analysis application 112 on the user devices 104, which enables the users to be able to access the server system 102 on the user devices 104. Further, the instance of the threat analysis application 112 may provide an alert in real-time to the users of the threat analysis application 112 about any new cyber threats published on the threat sources 106.

For instance, the user devices 104 may include any suitable electronic or computing devices such as a smartphone, a personal computer, a laptop, a personal digital assistant (PDA), an electronic tablet, a desktop computer, a wearable device, a smart device such as smart TV or smart appliance, a smartwatch, etc., among other suitable electronic devices. Further, the users may be any individual, organization, representative of a corporate entity, a non-profit organization, or any other person who needs to be updated with all the latest threats published in the market. Moreover, the users may be any individual who needs insights about the latest threats and available solutions implemented for addressing such threats. Alternatively, the users may be cyber threat analysts who not only need to be updated with all the latest threats but are also involved in analyzing the latest cyber threats and providing solutions for dealing with such cyber threats.

Similarly, for instance, the threat sources 106 may include open sources, premium sources, SaaS tooling, and the like. The threat sources 106 may provide the plurality of threat feeds that are published in the public domain which can be a publication or knowledge that others record or document for giving timely information about the cyber threats. In one embodiment, the threat sources 106 are associated with a third-party server or can be implemented in cloud as SaaS. The third-party server may provide or host the one or more conventional threat analysis platforms for analyzing latest cyber threats and generating the plurality of threat feeds. In another embodiment, the threat sources 106 are associated with threat devices, wherein the threat devices are any suitable electronic or computing devices similar to the user devices 104. The threat devices may have one or more conventional threat analysis platforms running on the threat devices, for analyzing the latest cyber threats and generating the plurality of threat feeds. Moreover, in an instance, the threat sources 106 may be operated by other cyber threat analysts or vendors who are involved in analyzing the cyber threats and providing solutions for dealing with such cyber threats. Thus, for example, the plurality of threat feeds includes information corresponding to the cyber threats analyzed by such vendors and the solutions for dealing with such cyber threats, newly disclosed vulnerabilities, newly discovered malware samples, newly registered malicious infrastructure, newly registered malicious certificates, brand infringements, leaked datasets, alerts from cyber security tooling, and the like. For example, the alerts from the cyber security tooling may correspond to the alerts that may be received from the SaaS tooling. This information may be available in the form of news articles, reports, tweets, blogs, and the like. Thus, the plurality of threat feeds may include news articles, threat posts, threat reports from vendors, conversations and analysis from around the world, tweets from vendors and researchers, and the like.

The database 108 may be adapted to store basic information, such as, but not limited to, details of the users, the threat sources 106, a cyber threat, a threat actor, a recent threat event, a malware, and the like. Further, the database 108 may also include information related to news articles, threat reports from vendors, results of “trip wires” going off in threat-detecting tools, tweets from the vendors and researchers, and the like. In an example, the vendors and the researchers may be associated with the threat sources 106. Furthermore, the database 108 includes the threat-related information (also referred to as the threat feeds) received from the threat sources 106.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 110 may include multiple different networks, such as a private network made accessible by the server system 102 and a public network (e.g., the Internet, etc.) through which the server system 102 may communicate.

It should be noted that the number of users, the user devices, and the threat sources described herein are only used for exemplary purposes and do not limit the scope of the invention. The main objective of the invention is to provide a platform for aggregating all the threat feeds on a single dashboard. This is followed by providing an updated insight into any latest threat published in any threat-related source to the users, based on the analysis of the aggregated threat feeds.

Consider an example, where a user is a threat analyst of an Information Technology (IT) organization 114 working with computers, servers, mobile devices, electronic systems, networks, data, and the like. The user is working on tracking cyber threats and responding quickly with solutions to protect the IT organization 114 from any kind of cyber-attacks. The user needs to install the threat analysis application 112 on the user device 104a and register oneself and the IT organization 114 with the threat analysis application 112. Upon registration, the user can stay updated with any new threat introduced in the market. Alternatively, if the user is not using the threat analysis application 112, then the user may be monitoring every source manually or by using conventional means, for staying updated with any latest published threat. However, it is difficult for the user to keep a track of every single source, and check if some new threat is published by any threat-related source.

Thus, in an embodiment, for the threat analysis application 112 to facilitate the user to stay updated with latest cyber threats, the server system 102 associated with the threat analysis application 112 is configured to aggregate a plurality of threat feeds (also referred to as threat feeds) corresponding to a plurality of threat events from a plurality of cyber threat-related sources (e.g., the threat sources 106a-106c). The plurality of threat events may correspond to act of detecting an occurrence of the cyber threats anywhere in the market which is now published in the public domain. Thus, the plurality of threat events may include publishing of news articles, threat reports, updates, blogs, and the like about the cyber threats.

In addition, the server system 102 facilitates the user to select one or more of the threat sources 106a-106c displayed on a user interface (UI) of the user device 104a, from whom the user is willing to aggregate the threat feeds. Upon selecting the threat sources (e.g., threat sources 106a-106c), content of the threat sources 106 is polled and pulled through Really Simple Syndication (RSS) feeds of the threat sources 106.

Furthermore, for detecting the plurality of threat events, the threat feeds are aggregated from the threat sources 106 by ingesting the threat feeds through a Representational State Transfer (REST) Application Programming Interface (API) associated with the threat sources 106. The REST API is a way for two computer systems to communicate using the Hypertext Transfer Protocol (HTTP) technologies found in web browsers and servers. For example, consider the threat source 106a on which the threat feeds are published by a particular vendor is a first computing device and the threat analysis application 112 that aggregates the published threat feeds is on a second computing device. The REST API enables the transfer of the threat feeds from the first computing device to the second computing device.

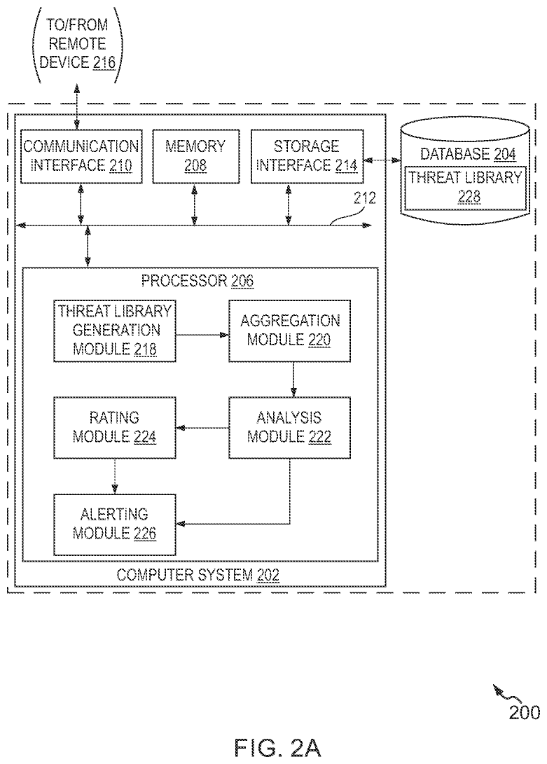

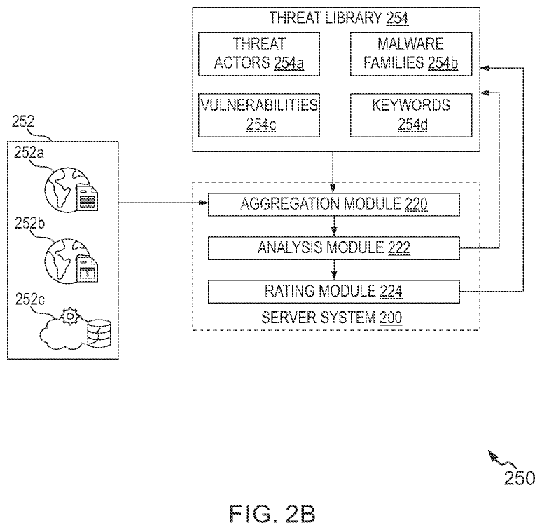

The server system 102 processes and compares the aggregated threat feeds with pre-stored data. For example, the pre-stored data includes a plurality of threat entities from a threat library. The threat library may be located in the database 108 of the server system 102. Further, the threat library includes the plurality of threat entities segregated under different threat categories. The plurality of threat entities may include a list of threat actors, malware families, a list of vulnerabilities, a list of keywords, threat clusters, and the like. Thus, the different threat categories may include a threat actor category, a malware family, a vulnerability category, a predefined keyword category, and a threat cluster category. As used herein, the term “threat cluster” refers to a combined set of threat actors, malware, vulnerabilities, and keywords. For example, a ransomware could be categorized under the threat cluster category. Further, content of the threat library and examples of the threat sources 106 are explained in more detail in further parts of the description with reference to FIG. 2B.

Furthermore, the plurality of threat entities may be linked with each other based on a relationship between the plurality of threat entities. Moreover, the threat library may be updated with this information. In addition, each of the plurality of threat entities may be associated with a threat severity rating in the threat library. In an embodiment, the server system 102 may be configured to facilitate assigning the threat severity rating to each of the plurality of threat entities, based, at least on a predefined threat rating strategy. The threat severity rating may be measured using a severity measuring scale having ratings ranging between certain ranges. Thus, the threat severity rating may be Baseline, Low, Medium, High, Severe, Emergency, or the like. The predefined threat rating strategy and the severity scale are pre-defined by a Cybersecurity and Infrastructure Security Agency (CISA) National Cyber Incident Scoring System.

Moreover, for processing and comparing the aggregated threat feeds with the pre-stored data, the server system 102 is configured to access the plurality of threat entities from the threat library. The server system 102 is further configured to identify one or more threat elements corresponding to at least one threat entity of the plurality of threat entities, in at least one threat feed of the plurality of threat feeds. Further, the server system 102 is configured to link the at least one threat feed with the at least one threat entity, based at least on the identification of the one or more threat elements in the at least one threat feed, for categorizing the one or more threat-related events under a predefined threat category. The predefined threat category includes a threat actor, a malware family, a vulnerability, a predefined keyword, or a threat cluster.

The aggregated data from external sources (e.g., the threat sources 106) and the content from the threat library are monitored and analyzed to establish a link between them. The monitored threat feeds from the external sources get analyzed and linked to matched threat entities in the threat library. Therefore, for example, the one or more threat elements include words, synonyms, and regexes corresponding to the at least one threat entity of the plurality of threat entities in the threat library.

Moreover, the server system 102 is further configured to generate one or more threat-related insights on the one or more threat-related events, based at least on the linking. The server system 102 is further configured to assign a predefined rating to the at least one threat feed that is linked with the at least one threat entity. The server system 102 assigns the predefined rating, based, at least on the one or more threat-related insights and the threat severity rating associated with each of the plurality of threat entities in the threat library. For example, the server system 102 may be configured to assign the predefined rating to the at least one threat feed, wherein the predefined rating corresponds to a highest rating of the plurality of threat entities in the threat library that the at least one threat feed is linked to. Thus, the predefined rating may include Baseline, Low, Medium, High, Severe, Emergency, or the like.

For example, the user rated the threat actor “APT99” as ‘medium’ threat and rated the malware “FASTCAR” as ‘baseline’ threat in the threat library. Then, suppose a report is having the threat actor “APT99” and the malware “FASTCAR” both mentioned in the report. Then, the report is linked with the corresponding threat actor and the malware. Further, the rating that the report gets assigned corresponds to ‘medium’, as that rating is the highest rating. In another example, the threat entities may be listed on a blacklist or on a grey list, where black-listed entities may be considered to represent high-severity cyber risks and grey-listed entities may be considered to represent medium-severity cyber risks.

Moreover, in an embodiment, the server system 102 may further be configured to prioritize one or more cyber threats to be addressed for cyber security of at least one organization (e.g., IT organization 114), based at least on the predefined rating assigned to the at least one threat feed. Further, the server system 102 is also configured to generate one or more alerts corresponding to the one or more cyber threats to be addressed for the cyber security of the at least one organization, based at least on the prioritization of the one or more cyber threats.

In some embodiments, the server system 102 may be configured to generate a threat card corresponding to the at least one threat entity that is linked with the at least one threat feed. The threat card may include insights on the at least one threat entity, event details about the threat events related to the at least one threat feed, a list of threat sources from where the at least one threat feed is obtained, a source type, a timestamp, and the like. Further, the server system 102 may also be configured to update the plurality of threat entities, and the threat severity rating associated with each of the plurality of threat entities in the threat library, based at least on, the one or more threat-related insights, and the insights on the at least one threat entity presented by the threat card.

In addition, in an instance, the server system 102 may further determine a popularity rating corresponding to each of the plurality of cyber threat-related sources 106, based at least on, a read report percentage associated with the plurality of cyber threat-related sources 106. For example, the server system 102 assigns a good popularity rating to the threat sources 106 when the read report percentage is greater than a predefined threshold value. Alternatively, the server system 102 assigns a bad popularity rating to the threat sources 106 when the read report percentage is less than the predefined threshold value. Thus, the threat sources 106 that are accessed or read by a greater number of people may have a good rating, and the threat sources 106 that are accessed by a smaller number of people may have a bad rating. Further, based on the popularity rating, a popularity of the threat sources 106 may be known.

FIG. 2A illustrates a simplified block diagram of a server system 200, in accordance with an embodiment of the present disclosure. For example, the server system 200 is similar to the server system 102 as described in FIG. 1. In some embodiments, the server system 200 is embodied as a standalone physical server and/or having a cloud-based and/or SaaS-based (software as a service) architecture. The server system 200 is configured to facilitate the aggregation and analysis of the plurality of threat feeds to provide insights to the users about the latest cyber threats published in the market.

The server system 200 includes a computer system 202 and a database 204. The computer system 202 includes at least one processor, such as a processor 206 for executing instructions, a memory 208, a communication interface 210, a bus 212, and a storage interface 214. The bus 212 enables entities of the computer system 202 to communicate with each other. The database 204 is an example of the database 108 of FIG. 1.

In some embodiments, the database 204 is integrated within the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

It is to be noted that although the computer system 202 is depicted to include only one processor, the computer system 202 may include a greater number of processors therein. The processor 206 includes a suitable logic, circuitry, and/or interfaces to execute computer-readable instructions for performing one or more operations for implementing cyber threat analysis. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like.

In an embodiment, the memory 208 is capable of storing the computer-readable instructions. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the computer system 202 is capable of communicating with a remote device 216 such as the user devices 104, the threat sources 106, or with any entity connected to the network 110 (as shown in FIG. 1). In one embodiment, the processor 206 is configured to facilitate installing an instance of the threat analysis application 112 corresponding to the server system 102 on the user devices 104. This enables implementation of a plurality of functionalities by multiple entities described in the disclosure.

It is to be noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2A.

The processor 206 is depicted to include a threat library generation module 218, an aggregation module 220, an analysis module 222, a rating module 224, and an alerting module 226. It should be noted that components, described herein, can be configured in a variety of ways, including electronic circuitries, digital arithmetic and logic blocks, and memory systems in combination with software, firmware, and embedded technologies.

Upon installing the threat analysis application 112 on the user devices 104, the server system 200 facilitates the users to generate a threat library 228 via the threat library generation module 218. Thus, the threat library generation module 218 is configured to generate the threat library 228 by creating a plurality of threat entities based, at least on historic data corresponding to a plurality of predetermined cyber threats associated with at least one organization. The plurality of threat entities may include a list of threat actors, malware families, a list of vulnerabilities, a list of keywords, and the like. The keywords may be defined by the users, the keywords being related to past cyber-attacks.

The threat library generation module 218 is further configured to generate the threat library 228 by linking the plurality of threat entities with each other based, at least on a predetermined relationship between the plurality of threat entities. For example, if it is known that a threat actor ‘x’ has used a piece of malware ‘y’ in a past cyber-attack, then the threat actor ‘x’ is linked with the piece of malware ‘y’ in the threat library 228. In an instance the threat library 228 may be located in the database 204 as shown in FIG. 2A.

Further, the threat library generation module 218 is configured to facilitate assigning of the threat severity rating to each of the plurality of threat entities, based, at least on a predefined threat rating strategy. For example, the threat severity rating may be Baseline, Low, Medium, High, Severe, Emergency, or the like.

Alternatively, the threat library 228 may be pre-generated and pre-stored in the database 204. Generally, the threat library 228 may include information about a considerable number of previously defined threats enlisted under the plurality of threat entities. Further, the content of the threat library 228 may be accessed by the server system 200 for further processing. Thus, the server system 200 accesses the plurality of threat entities from the threat library 228 via the aggregation module 220. Thus, the aggregation module 220 is configured to access the plurality of threat entities from the threat library 228.

Further, the aggregation module 220 is also configured to aggregate the plurality of threat feeds corresponding to the one or more threat-related events, from the plurality of cyber threat-related sources 106. The aggregation module 220 fetches and brings together disparate threat-related information (the threat feeds) from all the threat-related sources 106 into the threat analysis platform 112. The aggregation of the threat feeds in a single platform provides a user-friendly and convenient way to the users for taking a quick glance at all the threat-related information available in the market.

Further, the analysis module 222 is configured to search for threat elements corresponding to the at least one threat entity of the plurality of threat entities, in the aggregated threat feeds. Later, the analysis module 222 is configured to link at least one threat feed of the aggregated threat feeds with the at least one threat entity, based at least on the identification of the one or more threat elements in the at least one threat feed, for categorizing the one or more threat-related events under a predefined threat category. The predefined threat category includes a threat actor, a malware family, a vulnerability, a predefined keyword, or a threat cluster. Furthermore, the analysis module 222 is further configured to generate the one or more threat-related insights on the one or more threat-related events, based at least on the linking.

Furthermore, the rating module 224 is configured to assign the predefined rating to the at least one threat feed that is linked with the at least one threat entity, based at least on the one or more threat-related insights and the threat severity rating associated with each of the plurality of threat entities in the threat library 228.

In addition, in some embodiments, the server system 200 may further include an authentication module (not shown in FIG. 2A), a prioritization module (not shown in FIG. 2A), a threat card generation module (not shown in FIG. 2A), and a library updating module (not shown in FIG. 2A).

Thus, in an embodiment, the prioritization module may be configured to prioritize the one or more cyber threats to be addressed for cyber security of at least one organization (e.g., IT organization 114), based at least on the predefined rating assigned to the at least one threat feed. Further, the alerting module 226 is configured to generate the one or more alerts corresponding to the one or more cyber threats to be addressed for the cyber security of the at least one organization, based at least on the prioritization of the one or more cyber threats. The one or more alerts may also be generated if a new cyber threat is published in any threat-related sources. The alerting module 226 determines whether to issue the one or more alerts indicating that the one or more cyber threats have occurred at any of the cyber threat-related sources in response to the cumulative risk value.

Furthermore, in an embodiment, the threat card generation module may be configured to generate a threat card corresponding to the at least one threat entity that is linked with the at least one threat feed. The threat card may include insights on the at least one threat entity, event details about the threat events related to the at least one threat feed, a list of threat sources from where the at least one threat feed is obtained, a source type, a timestamp, and the like.

Moreover, in an embodiment, the library updating module may be configured to update the plurality of threat entities, and the threat severity rating associated with each of the plurality of threat entities in the threat library, based at least on, the one or more threat-related insights, and the insights on the at least one threat entity presented by the threat card.

In addition, the rating module 224 may further be configured to determine a popularity rating corresponding to each of the plurality of cyber threat-related sources 106, based at least on, a read report percentage associated with the plurality of cyber threat-related sources 106. For example, the server system 102 assigns a good popularity rating to the threat sources 106 when the read report percentage is greater than a predefined threshold value.

For instance, in case of a premium source 252b, the authentication module may be configured to facilitate a transfer of the API-keys to the premium source 252b, for unlocking access to a REST API of the premium source 252b for the users for accessing the data collected by the premium source 252b.

FIG. 2B illustrates a simplified block diagram 250 representing examples for the plurality of threat-related sources and the content of the threat library, in accordance with an embodiment of the present disclosure. FIG. 2B is shown to include the plurality of threat-related sources (e.g., threat sources 252), the server system 200, and the threat library (e.g., threat library 254). The server system 200 aggregates the threat feeds related to threat events from the threat sources 252. The threat feeds may include entries or records that identify external sources which are likely to be the sources of cyber threats. The threat feeds may further an identity of the external source (e.g., an IP address) and other metadata that characterizes or describes the nature of the cyber threat linked to that external source. Further, the external sources may refer to any communication tools or channels used to present the latest updates and information related to cyber threats in the form of threat feeds such as posts, blogs, articles, news, and the like. The threat feeds may further include written reports, newly disclosed vulnerabilities, malware and/or criminal infrastructure, and the like. The threat events may correspond to publishing of the posts, the blogs, the articles, the written reports, and the like corresponding to pre-determined cyber threats and latest cyber threats, discovered in the market.

Further, in an instance, the threat sources 252 may include an open source 252a, a premium source 252b, and a software as a service (SaaS) tooling 252c. In an example, the open source 252a is a source of the threat feeds accessible to everyone at any time. Many sources offer freemium services to tempt the usage of their paid services. The open source 252a may include, but is not limited to, open source websites and security news, Malware Information Sharing Platform (MISP) Threat Sharing (MISP)™, Open Cyber Threat Intelligence (Open CTI)™, Collective Intelligence Framework (CIF)™, Trusted Automated Exchange of Indicator Information (OpenTAXII)™, and the like.

Furthermore, the threat feeds are aggregated from the open source 252a by ingesting the threat feeds through the REST API associated with the open source 252a. Moreover, since, the open source 252a is accessible to anyone for free of charge, the REST API of the open source 252a can also be accessed by anyone without a need for authentication.

The premium source 252b (also termed as a paid-for source 252b) is a source of threat feeds that is only accessible to subscribed users. The premium source 252b provides the immediate and dramatic increase in the ability to uncover hidden adversaries in the early stages of an attack. The premium source 252b may include, but not be limited to, FortiGuard™, Watchguard™, Mandiant™, CrowdStrike™, Recorded Future™, Kaspersky™, and the like.

Further, in case of the premium source 252b, the premium source 252b or vendors of the premium source 252b may provide access to a REST API of the premium source 252b upon receiving a payment for a subscription plan for accessing data collected by the premium source 252b. Furthermore, for accessing the REST API of the premium source 252b, the users may have to provide API-keys (e.g., a private key and a public key). This allows the users to pull the data from the premium source 252b as the threat feeds, upon authentication of the users based, at least on the API-keys. The threat analysis application 112 may pull content or data from the open source 252a, and the premium source 252b after every predefined interval. For example, the predefined interval may correspond to 10 minutes.

Moreover, the SaaS tooling 252c allows the users to pay and set “trip wires” by creating signatures and monitoring rules. The trip wires may correspond to combining expert analyses and reports with relevant documents gathered directly from sources to help users anticipate, identify, and prevent improvised explosive devices (IED) incidents.

For example, SaaS tools include VirusTotal™ (for malware analysis), DomainTools™ and RiskIQ™ (for infrastructure monitoring) allow paying users to set up “trip wires” by creating signatures and monitoring rules. They also typically provide the REST API access, just like the premium source 252b described above. The threat analysis application 112 polls those SaaS platforms and pulls the alerts after every predefined interval to check if any of those “trip wires” have tripped. If they have, then the alert corresponding to the tripping of the trip wires gets ingested as a threat feed in the system and linked to the relevant threat entities in the threat library 254.

Further, it is known from the above description that the content of the threat library 254 is stored in an organized manner by segregating the content under the different threat categories. For instance, the threat categories may include a threat actor, a malware family, a vulnerability, a predefined keyword, or a threat cluster. In an embodiment, the server system 200 may be configured to generate the threat library 254 by creating the plurality of threat entities based, at least on historic data corresponding to a plurality of predetermined threat events associated with at least one organization. For instance, the plurality of threat entities may be related to the historic data corresponding to historical cyber threats that multiple organizations may have encountered at some point in time. The plurality of threat entities may further include keywords predefined by the user, the keywords being related to the cyber threats. Thus, the plurality of threat entities may include threat actors 254a, malware families 254b, vulnerabilities 254c, keywords 254d, and the like.

Further, the server system is configured to generate the threat library 254 by linking the plurality of threat entities with each other based, at least on a predetermined relationship between the plurality of threat entities. For example, if a certain threat actor uses a piece of malware in their cyber-attacks, then the user can create a link between the two.

Moreover, the threat library 254 may be updated with this information. In addition, each of the plurality of threat entities may be associated with a threat severity rating in the threat library 254. In an embodiment, the threat severity rating may be assigned to each of the plurality of threat entities by the user via the threat analysis application 112. In another embodiment, the server system 102 may pre-allocate the threat severity rating to each of the plurality of threat entities based, at least on a predefined threat rating strategy. For instance, the predefined threat rating strategy may be pre-defined as criticality rating by the CISA National Cyber Incident Scoring System. The threat severity rating may be measured using a severity measuring scale having ratings ranging between certain ranges. Thus, the threat severity rating may be Baseline, Low, Medium, High, Severe, Emergency, or the like. The severity scale is also pre-defined by the CISA National Cyber Incident Scoring System.

In an embodiment, the threat entities may be created based on analysis by software developers and/or cyber threat analysts of previously observed cyber-attacks. Thus, the threat entities may include historical experiences that any individual or multiple organizations may have encountered at some point in time. The analysis abstracts the specific characteristics of the historical attacks to recognize the general strategies employed in those attacks. The threat entities may include, but not limited to, name of the threat actor, threat actor aliases, malware names, malware aliases, vulnerability names, designations, and the like. Similarly, the keywords may words or terms defined by the user as input of the threat library 254.

In an example, consider the multiple organizations as any vendor of all shapes and sizes, IT Company, educational institute, Security Operation Centers (SOC), computer security incident response team (CSIRT), private bank, any individual, and the like. Any historical threat once encountered by any organization is stored in the database 204. The individuals that might have encountered threats previously may include Sec/IT analyst, Intel analysts, executive management, and the like. The Sec/IT analyst is security analyst that optimizes prevention and detection capabilities and strengthens defenses. Intel analysts uncovers and track threat actors targeting the organization.

In another example, diving deep into the types of the threat entities, consider a threat entity that is related to the threat actors 254a. A threat actor may be a person or a group of people that take part in an action to cause harm to a cyber realm. The cyber realm may include, but is not limited to computers, devices, systems, networks and the like. In another example, consider a threat entity is related to the malware families 254b. Malware is malicious software, file, or code intentionally designed to cause disruption to one or more devices such as a computer, server, or computer network, etc. The malware causes the effect of leaking private information, gaining unauthorized access to information, depriving access to information, or which unknowingly interferes with the user's computer security and privacy. In yet another example, consider the threat entity is related to the vulnerabilities 254c. A vulnerability is a weakness in one or more systems such as hardware, software, procedures, and the like that allows hackers to easily find their way into the system.

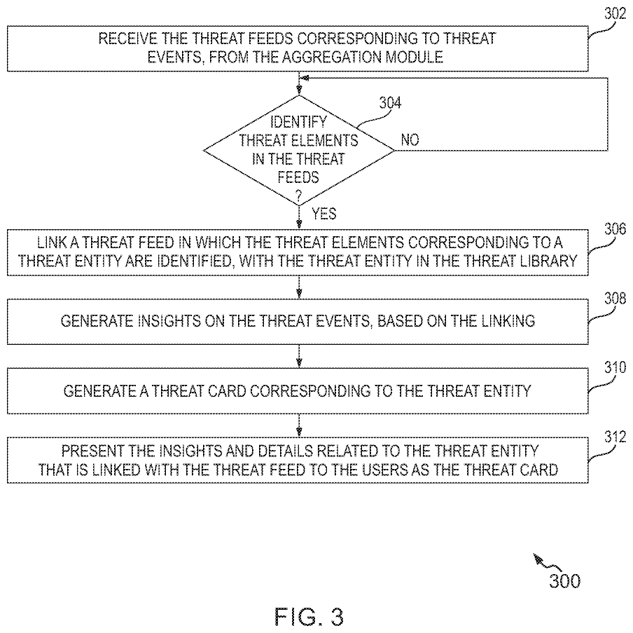

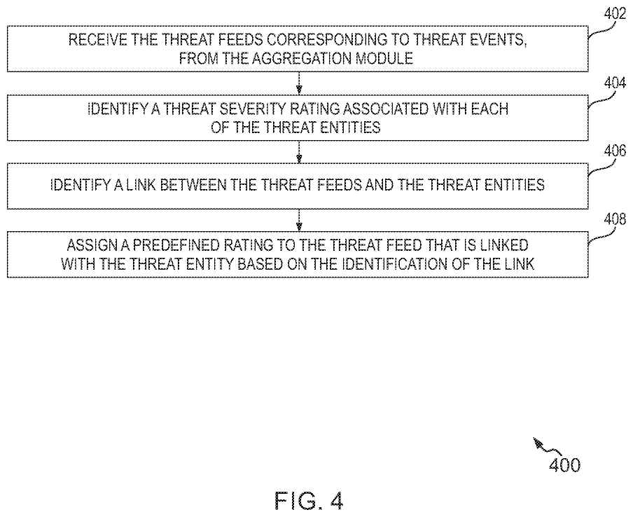

Further, the aggregation module 220 aggregates the threat feeds from the threat sources 252 and access the threat entities of the threat library 254. the aggregated data is provided to the analysis module 222. The analysis module 222 may analyze the threat feeds and further provides analysis results to the rating module 224. The rating module 224 may assign the predefined rating to the threat feeds. Further, the threat entities in the threat library are updated, and this process repeats in real-time. Furthermore, a process flow of analyzing the threat feeds which is carried out by the analysis module is explained in detail in further parts of the description with reference to FIG. 3. Similarly, a process flow of rating the threat feeds which is carried out by the rating module 224 is also explained in detail in further parts of the description with reference to FIG. 4.

FIG. 3 is a flow diagram 300 depicting a process flow of analyzing the plurality of threat feeds, in accordance with an embodiment of the present disclosure. The process flow of analyzing the plurality of threat feeds is implemented by the analysis module 222 of the server system 200. The flow of the flow diagram 300 starts at 302.

At step 302, the analysis module 222 receives the plurality of threat feeds from the aggregation module 220. The aggregation module 220 aggregates the threat feeds from the threat sources 106 by ingesting the threat feeds into the threat analysis application 112 through the REST API of the threat sources.

At step 304, the analysis module 222 identifies the one or more threat elements corresponding to the plurality of threat entities present in the threat library, in the threat feeds.

In one scenario, upon identifying the one or more threat elements in at least one threat feed from the plurality of threat feeds, the process flow proceeds to step 306. For example, the one or more threat elements include words, synonyms, and regexes corresponding to the at least one threat entity of the plurality of threat entities in the threat library. The term ‘regex’ is a sequence of characters that specifies a search pattern in the text for matching strings or pieces of strings.

At step 306, the analysis module 222 links a threat feed in which the threat elements corresponding to a threat entity are identified with the threat entity in the threat library. This linking may be done for categorizing the one or more threat-related events under a predefined threat category. The predefined threat category includes a threat actor, a malware family, a vulnerability, a predefined keyword, or a threat cluster. For example, parsed threat feed is about the threat actor “APT99” and malware “FASTCAR” will get linked to same threat entities that is threat actor “APT99” and malware “FASTCAR” in the threat library.

In another example, suppose a malware named ‘malware-xyz’ and a threat actor named ‘threat actor-uvw’ are enlisted in the threat library under the malware families and the list of threat actors of the plurality of threat entities respectively. Further, suppose a report aggregated by the server system 102 as a threat feed, includes elements such as the malware named ‘malware-xyz’ used by the threat actor named ‘threat actor-uvw’. Then, upon identifying such elements that are related to the plurality of threat entities of the threat library, in the report, the server system 102 links the report with a corresponding threat entity of the plurality of threat entities. In this example, the report is linked with the threat entities such as the malware families and the list of threat actors, associated with specified information. The specified information may include details about the identified elements that are related to a particular malware and a particular threat actor.

Alternatively, upon failing to identify the one or more matching threat elements in at least one threat feed from the plurality of threat feeds, the process flow proceeds back with step 304, and monitors more of the threat feeds from the aggregator for identifying the threat elements.

At step 308, the server system 102 generates a valuable insights on the threat events from the aggregated data, based on the linking. The plurality of threat-related insights (also termed as threat-related insights/valuable insights) may correspond to a system-generated insight about the linking of a threat feed with a threat entity of the threat library. For example, an insight about the publishing of the report may include that ‘the report is linked with a malware family and a threat actor of the threat library’. Further, the insight may be associated or tagged with further information about the linking such as name of the malware and a name of the threat actor that are identified to be present in the threat feed, a link between the threat actor and the malware, a threat severity rating associated with the malware and the threat actor identified in the threat feed, and the like.

At step 310, the serve system 102 generates a threat card corresponding to the threat entity to which the threat feed linked. The threat card may include insights on the at least one threat entity, event details about the threat events related to the at least one threat feed, a list of threat sources from where the at least one threat feed is obtained, a source type, a timestamp, and the like. At 312, the server system 102 presents the valuable insights as a threat card to the application user.

The threat cards may be considered as a message provided to users for visualizing the valuable insights determined by the platform. The threat card represents the insights in an organized and convenient way that keep users updated with the latest threat feeds and their metadata.

FIG. 4 is a flow diagram 400 depicting a process flow of rating the plurality of threat feeds, in accordance with an embodiment of the present disclosure. The process flow of analyzing the plurality of threat feeds is implemented by the rating module 224 of the server system 200. The flow of the flow diagram 400 starts at 402.

At step 402, server system 102 receives the threat feeds corresponding to the threat events, from the aggregation module 220.

At step 404, server system 102 identifies a threat severity rating associated with each of the threat entities.

The step 404 is explained as, upon defining the threat entity in the threat library, the severity rating is also assigned to threat entities in the threat library by user. The threat severity rating may be measured using a severity measuring scale having ratings ranging between certain ranges. Thus, the threat severity rating may be Baseline, Low, Medium, High, Severe, Emergency, or the like. The predefined threat rating strategy and the severity scale are pre-defined by a Cybersecurity and Infrastructure Security Agency (CISA) National Cyber Incident Scoring System. For example, the user rated the threat actor “APT99” as MEDIUM threat and the user rated the malware “FASTCAR” as BASELINE threat.

At step 406, server system 102 identifies a link between received threat feeds and the threat entities in the threat library.

The step 406 is explained as, the threat feeds are monitored continuously and automatically by the application 112 running on the server system 102. The threat events may be the continuous occurrence of threats related instances on the market and corresponding threat feeds keep on publishing on threat-related sources. The server system 102 continuously chases all the threat-related sources and checks for all the latest threat feeds on the threat-related sources. The server system 102 may be further configured to parse all the threat feeds to identify one or more matching threat elements corresponding to the plurality of threat entities, wherein the threat entities are defined by users and stored in the threat library. For example, at least one of the threat feed is monitored from the plurality of threat feeds and identified the presence of key elements such as threat actor “APT99” and malware “FASTCAR” in the monitored threat feed. The server system 102 checks that identified key elements that are threat actor “APT99” and malware “FASTCAR” is also present in the threat library as user-defined threat entities. Upon identifying the matching threat elements in the threat feed and the threat entities, the threat feed is linked with the matched threat entities.

Upon identifying the link between the threat feeds and the threat entities, the process flow proceeds to step 408, at step 408, the server system 102 assigns the pre-defined rating to the threat feed that is linked with the threat entity based on the identification of the link.

The step 408 is explained as, the threat feeds not only get linked with corresponding threat entities but also follow the highest rating of the entities it is linked to. For example, the threat feed is about threat actor “APT99” using malware “FASTCAR” is published. The user has rated the threat actor “APT99” as a MEDIUM threat and the malware “FASTCAR” as a BASELINE threat. The threat feed will therefore be rated as a “MEDIUM” threat as “MEDIUM” is the highest rating among the linked entities.

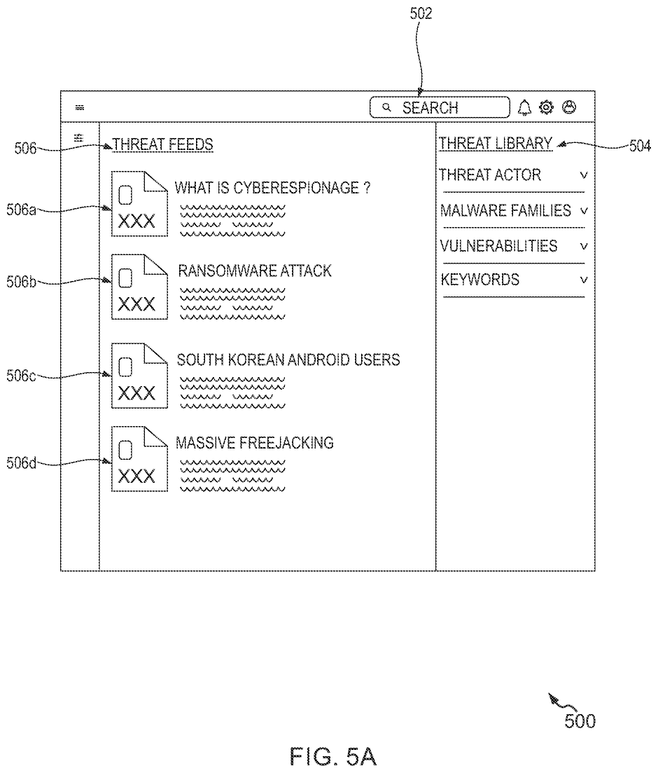

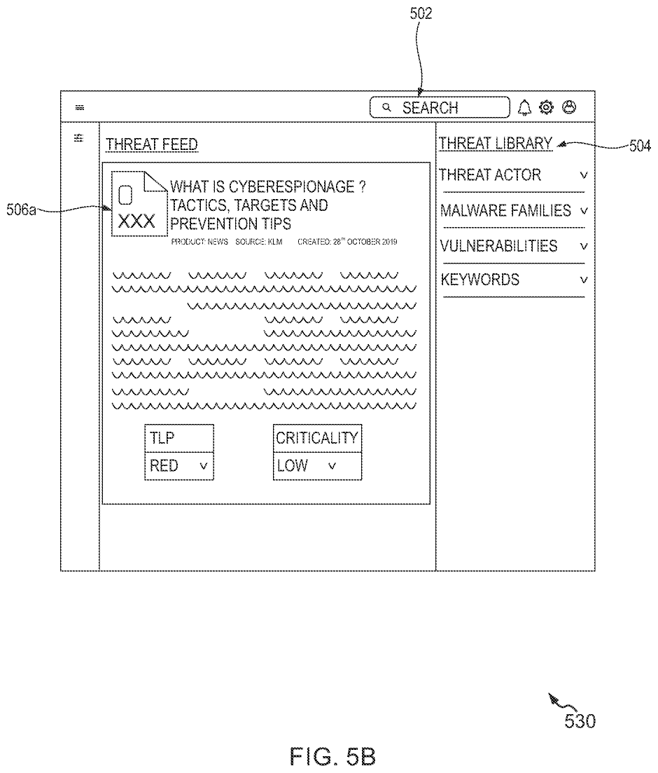

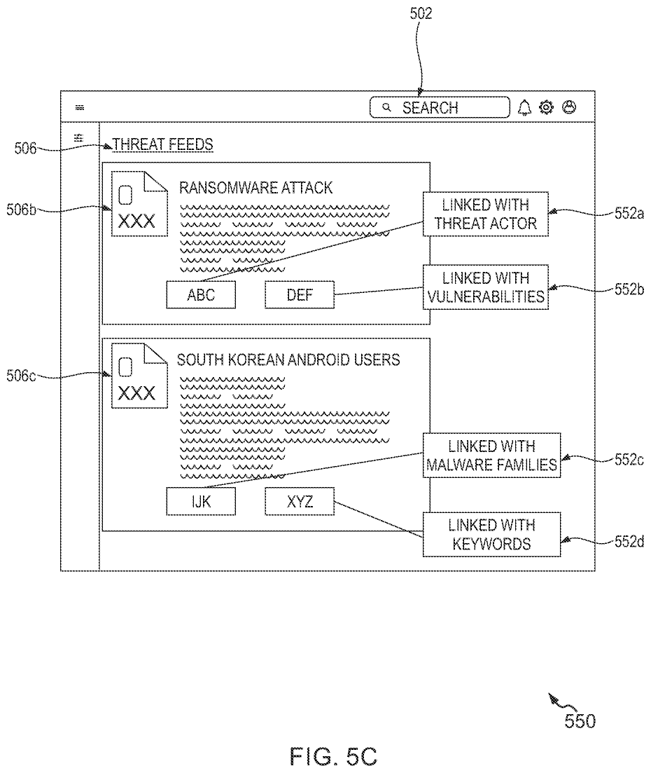

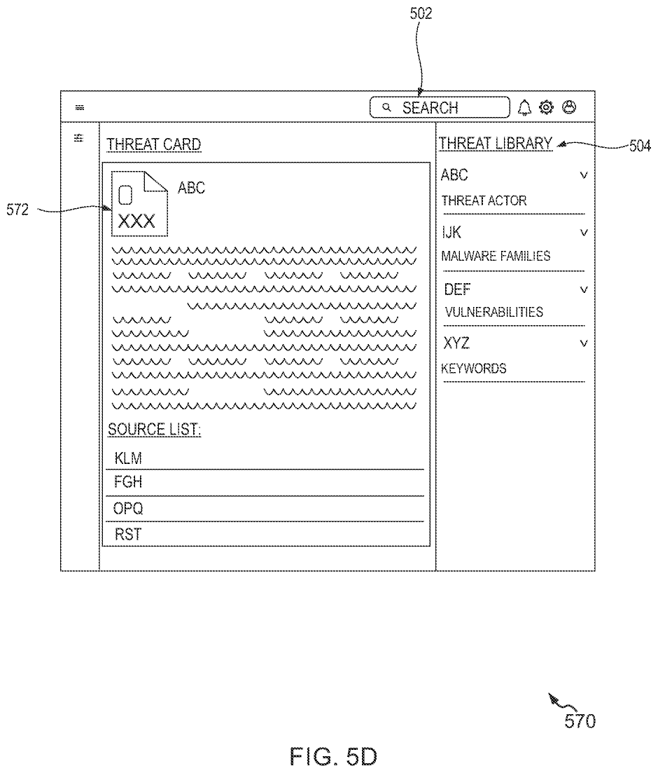

FIGS. 5A, 5B, 5C, and 5D, collectively, represent an example representation of User Interfaces (UIs) rendered in an application for cyber security analysis, in accordance with an example embodiment of the present disclosure.

UI 500 displays a home page of the threat analysis application 112 that provides a list of threat feeds 506a-506d (collectively referred to as threat feeds 506), wherein threat feeds 506 are the aggregated published data such as any post, news, or article related to a threat. The UI 500 may further include a search bar 502 at the right top corner of the home page which allows the users to search any particular threat feed by its title or keywords. The search bar 502 may also allow the users to search for any particular threat entity. Furthermore, the UI 500 may display a threat library 504 at the right side of the home page that provides the users with the list of the threat entities such the threat actor, the malware families, vulnerabilities, and keywords.

UI 530 displays the detailed view of at least one threat feed 506a from the list of threat feeds 506a-506d by opening the threat feed 506a into the detailed view, upon performing tapping, clicking, or any other gestures on the particular threat feed. The detailed view of at least one threat feed 506a may include and display the content such as threat actor names, threat actor aliases, malware names, malware aliases, vulnerability names, detailed description of threat etc. For example, if the threat feed 506a is a threat report, then the content of the report may include a title corresponding a cyber threat, a source name, a type of the source, a timestamp, description of the cyber threat mentioned in the title, and the like. The UI 530 may also display a Traffic Light Protocol (TLP) drop down and a criticality drop down. TLP indicates sharing restrictions in the intelligence community. If TLP is ‘WHITE’, then the information disclosed in the report is considered open source and meant to be public. Further, if TLP is ‘RED’, then the information disclosed in the report is only meant for the eyes of the individual receiver. They are not allowed to share the information onwards. Further, the criticality refers to the threat severity rating which includes baseline, low, medium, high, severe, and emergency.

UI 550 displays insights such as ‘linked with threat actor’ 552a, ‘linked with vulnerabilities’ 552b, ‘linked with malware families’ 552c, and ‘linked with keywords’ 552d on the threat events corresponding to cyber threats sited in the threat feeds 506. The insights may include and display the link between selected threat feed corresponding to a threat event and a threat entity in the threat library. Further insights may also provide the ranking of threat feeds 506.

The UI 550 displays the threat feed 502b in which threat elements ‘ABC’ and ‘DEF’ are sited which are corresponding to the threat entities a threat actor and vulnerabilities in the threat library respectively. Therefore, the insight 552a is provided for the threat element ‘ABC’, and the insight 552b is provided for the threat element ‘DEF’ as shown in the UI 550.

Similarly, the UI 550 also displays the threat feed 502c in which threat elements ‘IJK’ and ‘XYZ’ are sited which are corresponding to the threat entities malware families and keywords in the threat library respectively. Therefore, the insight 552c is provided for the threat element ‘IJK’, and the insight 552d is provided for the threat element ‘XYZ’ as shown in the UI 550.

UI 570 displays a threat card 572 generated by the threat analysis application 112 to provide and show every single detail of the at least one threat entity linked to the threat feed selected by the user. Insights represented in the threat card 572 may include, but are not limited to, threat event details such as the title of threat feed, type of source, actual source of threat feed, timestamp, content related to threat feed, and the like.

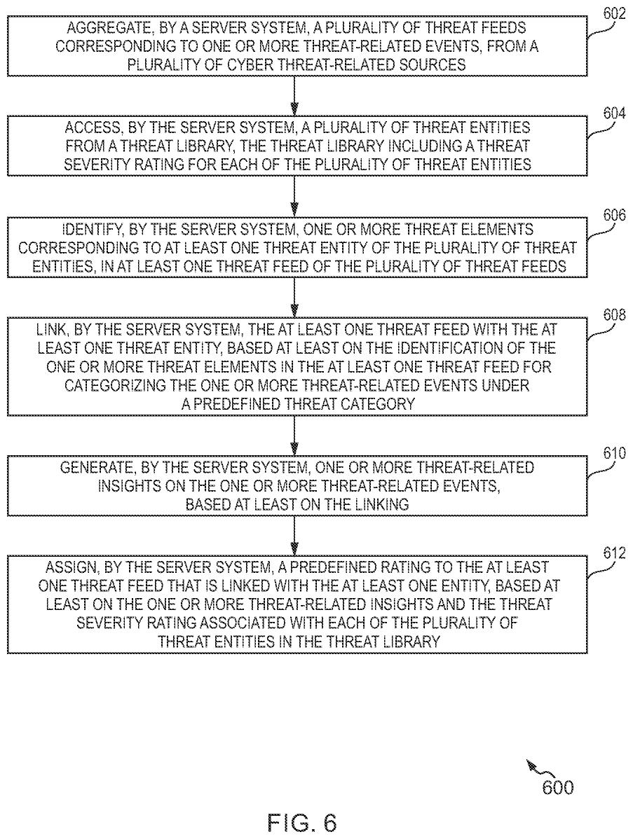

FIG. 6 is a flowchart illustrating a computer-implemented method 600 for cyber threat analysis, in accordance with an embodiment of the present disclosure. The method 600 depicted in the flow diagram may be executed by, for example, at least one server system. Operations of the flow diagram of the method 600, and combinations of operation in the flow diagram of the method 600, may be implemented by, for example, hardware, firmware, a processor, circuitry, and/or a different device associated with the execution of software that includes one or more computer program instructions. The method 600 starts at operation 602.

At 602, the method 600 includes aggregating, by the server system 102, a plurality of threat feeds corresponding to one or more threat-related events, from a plurality of cyber threat-related sources.

At 604, the method 600 includes accessing, by the server system 102, a plurality of threat entities from a threat library, the threat library including a threat severity rating for each of the plurality of threat entities.

At 606, the method 600 includes identifying, by the server system 102, one or more threat elements corresponding to at least one threat entity of the plurality of threat entities, in at least one threat feed of the plurality of threat feeds.

At 608, the method 600 includes linking, by the server system 102, the at least one threat feed with the at least one threat entity, based at least on the identification of the one or more threat elements in the at least one threat feed, for categorizing the one or more threat-related events under a predefined threat category.

At 610, the method 600 includes generating, by the server system 102, one or more threat-related insights on the one or more threat-related events, based at least on the linking.

At 612, the method 600 includes assigning, by the server system 102, a predefined rating to the at least one threat feed that is linked with the at least one threat entity, based at least on the one or more threat-related insights and the threat severity rating associated with each of the plurality of threat entities in the threat library.

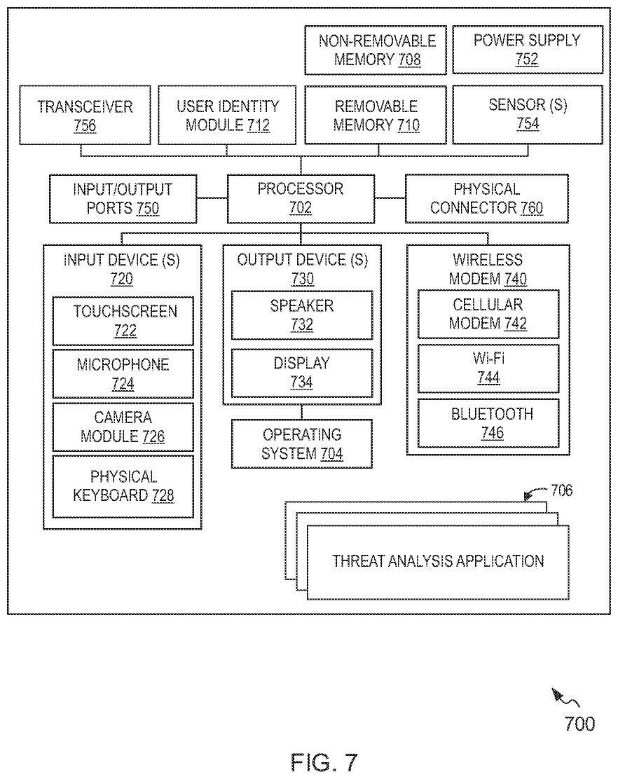

FIG. 7 shows simplified block diagram of a user device 700 for example a mobile phone or a desktop computer capable of implementing the various embodiments of the present disclosure. For example, the user device 700 may correspond to the user devices 104a-104c of FIG. 1. The user device 700 is depicted to include one or more applications such as a threat analysis platform 706 facilitated by the server system 102. The threat analysis platform 706 can be an instance of an application downloaded from the server system 102 or a third-party server. The threat analysis platform 706 is capable of communicating with the server system 102 for facilitating to visualize the threat feeds insights by the user via a dedicated threat analysis platform shown in FIG. 1.

It should be understood that the user device 700 as illustrated and hereinafter described is merely illustrative of one type of device and should not be taken to limit the scope of the embodiments. As such, it should be appreciated that at least some of the components described below in connection with the user device 700 may be optional and thus in an example embodiment may include more, less, or different components than those described in connection with the example embodiment of the FIG. 7. As such, among other examples, the user device 700 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 700 includes a controller or a processor 702 (e.g., a signal processor, microprocessor, ASIC, or other control and processing logic circuitry) for performing such tasks as signal coding, data processing, image processing, input/output processing, power control, and/or other functions. An operating system 704 controls the allocation and usage of the components of the user device 700 and supports one or more applications programs such as the threat analysis platform 706, that implements one or more of the innovative features described herein. In addition to the threat analysis platform 706, the applications may include common mobile computing applications (e.g., telephony applications, email applications, calendars, contact managers, web browsers, messaging applications) or any other computing application.

The illustrated user device 700 includes one or more memory components, for example, a non-removable memory 708 and/or removable memory 710. The non-removable memory 708 and/or the removable memory 710 may be collectively known as a database in an embodiment. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704 and the threat analysis platform 706. The user device 700 may further include a user identity module (UIM) 712. The UIM 712 may be a memory device having a processor built in. The UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 700 can support one or more input devices 720 and one or more output devices 730. Examples of the input devices 720 may include, but are not limited to, a touch screen/a display screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include, but are not limited to, a speaker 732 and a display 734. Other possible output devices can include piezoelectric or other haptic output devices. Some devices can serve more than one input/output function. For example, the touch screen 722 and the display 734 can be combined into a single input/output device.

A wireless modem 740 can be coupled to one or more antennas (not shown in the FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device or a local wireless data network or router, and/or a Bluetooth-compatible modem 746. The wireless modem 740 is typically configured for communication with one or more cellular networks, such as a GSM network for data and voice communications within a single cellular network, between cellular networks, or between the user device 700 and a public switched telephone network (PSTN).

The user device 700 can further include one or more input/output ports 750, a power supply 752, one or more sensors 754 for example, an accelerometer, a gyroscope, a compass, or an infrared proximity sensor for detecting the orientation or motion of the user device 700 and biometric sensors for scanning biometric identity of an authorized user, a transceiver 756 (for wirelessly transmitting analog or digital signals) and/or a physical connector 760, which can be a USB port, IEEE 794 (Fire Wire) port, and/or RS-232 port. The illustrated components are not required or all-inclusive, as any of the components shown can be deleted and other components can be added.

The disclosed method with reference to FIG. 6, or one or more operations of the method 600 may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 102 and its various components such as the computer system 202 and the database 204 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
aggregating, by a server system, a plurality of threat feeds corresponding to one or more threat-related events, from a plurality of cyber threat-related sources;
accessing, by the server system, a plurality of threat entities from a threat library, the threat library comprising a threat severity rating for each of the plurality of threat entities;
identifying, by the server system, one or more threat elements corresponding to at least one threat entity of the plurality of threat entities, in at least one threat feed of the plurality of threat feeds;
linking, by the server system, the at least one threat feed with the at least one threat entity, based at least on the identification of the one or more threat elements in the at least one threat feed, for categorizing the one or more threat-related events under a predefined threat category;
generating, by the server system, one or more threat-related insights on the one or more threat-related events, based at least on the linking; and
assigning, by the server system, a predefined rating to the at least one threat feed that is linked with the at least one threat entity, based at least on the one or more threat-related insights and the threat severity rating associated with each of the plurality of threat entities in the threat library.

2. The computer-implemented method as claimed in claim 1, wherein the plurality of threat feeds comprises at least one of written threat reports, cyber news, threat blogs, newly disclosed vulnerabilities, newly discovered malware samples, newly registered malicious infrastructure, newly registered malicious certificates, brand infringements, leaked datasets, and alerts from cyber security tooling.

3. The computer-implemented method as claimed in claim 1, wherein the one or more threat elements comprise words, synonyms, and regexes corresponding to the at least one threat entity of the plurality of threat entities in the threat library.

4. The computer-implemented method as claimed in claim 1, wherein the predefined threat category comprises a threat actor, a malware family, a vulnerability, a predefined keyword, or a threat cluster.

5. The computer-implemented method as claimed in claim 1, further comprising facilitating, by the server system, assigning of the threat severity rating to each of the plurality of threat entities, based, at least on a predefined threat rating strategy, wherein the threat severity rating comprises Baseline, Low, Medium, High, Severe, and Emergency.

6. The computer-implemented method as claimed in claim 1, wherein assigning the predefined rating to the at least one threat feed comprises assigning a highest rating of the plurality of threat entities in the threat library that the at least one threat feed is linked to.

7. The computer-implemented method as claimed in claim 1, further comprising generating, by the server system, the threat library by:
creating the plurality of threat entities based, at least on historic data corresponding to a plurality of predetermined threats events associated with at least one organization, and
linking the plurality of threat entities with each other based, at least on a predetermined relationship between the plurality of threat entities.

8. The computer-implemented method as claimed in claim 1, further comprising prioritizing, by the server system, one or more cyber threats to be addressed for cyber security of at least one organization, based at least on the predefined rating assigned to the at least one threat feed.

9. The computer-implemented method as claimed in claim 8, further comprising generating, by the server system, one or more alerts corresponding to the one or more cyber threats to be addressed for the cyber security of the at least one organization, based at least on the prioritization of the one or more cyber threats.

10. The computer-implemented method as claimed in claim 1, further comprising generating, by the server system, a threat card for the at least one threat entity that is linked with the at least one threat feed, wherein the threat card comprises insights on the at least one threat entity, event details about the threat events related to the at least one threat feed, a list of threat sources from where the at least one threat feed is obtained, a source type, and a timestamp.

11. The computer-implemented method as claimed in claim 10, further comprising, updating, by the server system, the plurality of threat entities, and the threat severity rating associated with each of the plurality of threat entities in the threat library, based at least on, the one or more threat-related insights, and the insights on the at least one threat entity presented by the threat card.

12. The computer-implemented method as claimed in claim 1, further comprising, determining, by the server system, a popularity rating corresponding to each of the plurality of cyber threat-related sources, based at least on, a read report percentage associated with the plurality of cyber threat-related sources.

13. A server system, comprising:
a memory configured to store instructions;
a communication interface; and
a processor in communication with the memory and the communication interface, the processor configured to execute the instructions stored in the memory and thereby cause the server system to perform, at least in part, to:
aggregate a plurality of threat feeds corresponding to one or more threat-related events, from a plurality of cyber threat-related sources;
access a plurality of threat entities from a threat library, the threat library comprising a threat severity rating for each of the plurality of threat entities;
identify one or more threat elements corresponding to at least one threat entity of the plurality of threat entities, in at least one threat feed of the plurality of threat feeds;
link the at least one threat feed with the at least one threat entity, based at least on the identification of the one or more threat elements in the at least one threat feed, for categorizing the one or more threat-related events under a predefined threat category;
generate one or more threat-related insights on the one or more threat-related events, based at least on the linking; and
assign a predefined rating to the at least one threat feed that is linked with the at least one threat entity, based at least on the one or more threat-related insights and the threat severity rating associated with each of the plurality of threat entities in the threat library.

14. The server system as claimed in claim 13, further caused to facilitate assigning of the threat severity rating to each of the plurality of threat entities, based, at least on a predefined threat rating strategy, wherein the threat severity rating comprises Baseline, Low, Medium, High, Severe, and Emergency.

15. The server system as claimed in claim 13, further caused to generate the threat library by:
creating the plurality of threat entities based, at least on historic data corresponding to a plurality of predetermined threats events associated with at least one organization, and
linking the plurality of threat entities with each other based, at least on a predetermined relationship between the plurality of threat entities.

16. The server system as claimed in claim 13, further caused to prioritize one or more cyber threats to be addressed for cyber security of at least one organization, based at least on the predefined rating assigned to the at least one threat feed.

17. The server system as claimed in claim 16, further caused to generate one or more alerts corresponding to the one or more cyber threats to be addressed for the cyber security of the at least one organization, based at least on the prioritization of the one or more cyber threats.

18. The server system as claimed in claim 13, further caused to generate a threat card for the at least one threat entity that is linked with the at least one threat feed, wherein the threat card comprises insights on the at least one threat entity, event details about the threat events related to the at least one threat feed, a list of threat sources from where the at least one threat feed is obtained, a source type, and a timestamp.

19. The server system as claimed in claim 18, further caused to update the plurality of threat entities, and the threat severity rating associated with each of the plurality of threat entities in the threat library, based at least on, the one or more threat-related insights, and the insights on the at least one threat entity presented by the threat card.

20. The server system as claimed in claim 13, further caused to determine a popularity rating corresponding to each of the plurality of cyber threat-related sources, based at least on, a read report percentage associated with the plurality of cyber threat-related sources.
